(19) United States
(12) Patent Application Publication
(10) Pub. No.: US 2015/0034345 A1
(43) Pub. Date: Feb. 5, 2015

(54) ELECTRIC POWER TOOL

(71) Applicant: Basso Industry Corp., Taichung (TW)

(72) Inventors: Chien-Kuo Po, Taichung (TW); Jian-Rung Wu, Taichung (TW); Chia-Yu Chien, Taichung (TW)

(21) Appl. No.: 14/338,313

(22) Filed: Jul. 22, 2014

(30) Foreign Application Priority Data
Aug. 1, 2013 (TW) 102127610

(51) Int. Cl. B25F 5/00; B25C 1/06

(52) U.S. Cl. CPC B25F 5/008; B25C 1/06
USPC 173/46

(57) ABSTRACT

In an electric power tool, a flywheel can be driven by a driving unit to rotate about a wheel axis to thereby impart kinetic energy to a tool body through a force transmitting portion of the flywheel. A ventilating unit is mounted to rotate with the flywheel about the wheel axis. When the flywheel is driven to rotate, cooling air is generated by rotation of the ventilating unit.

### CROSS-REFERENCE TO RELATED APPLICATION

This application claims priority from Taiwanese application no. 102127610, filed on Aug. 1, 2013, the disclosure of which is incorporated in its entirety herein by reference.

### BACKGROUND OF THE INVENTION

1. Field of the Invention

This invention relates to an electric power tool, more particularly to an electric power tool with a ventilating unit.

2. Description of the Related Art

U.S. Pat. No. 8011549 discloses a flywheel configuration for a power tool. As disclosed in lines 50-54, col. 8 and FIG. 14 of said US patent, the flywheel includes a hub, an outer rim, and means for coupling the hub and the outer rim to one another. The coupling means may comprise a plurality of blades.

As the flywheel is configured to distribute energy to a driver so as to propel the driver, heat will be generated in a region around the flywheel and the driver.

Although the blades are employed to generate a flow of air when the flywheel rotates, since the flywheel is mounted inside a backbone, the air flow generated by the blades that are disposed close to the heat generating region is relatively hot. Thus, the blades cannot effectively dissipate the heat generated in the power tool.

U.S. Pat. No. 8,511,532B2 discloses a fastener driving tool, which includes a flywheel rotated by a drive unit and having a wheel rim formed with teeth, an impact member having a mating toothed unit movable with a carrier frame to engage the teeth so as to be swept thereby to an end-stroke position to enable a striking rod to drive a fastener into a targeted workpiece, and an actuating unit configured to actuate the carrier frame to move from an upper position to a lower position in response to a triggering action of a trigger so as to move the mating toothed unit from an disengaging position to an engaging position. However, said US patent is silent on the problem of dissipating heat generated around the flywheel.

U.S. patent application publication no. 2014/0076953 discloses a battery powered tool which includes a housing containing a motor assembly. A fan positioned in the housing is rotated by the motor assembly. The fan has a circular ring/body and further has multiple fan blades directly connected to the circular ring/body. The circular ring/body defines a concave shaped surface having the fan blades directly connected to the concave shaped surface. A housing cover includes: first and second extending walls; a slot created between the first and second extending walls; and multiple air intake vents all positioned in a lower housing zone separated from an upper housing zone by the slot. An electronics module is positioned in the housing proximate to the lower housing zone such that air entering the intake vents passes only through the lower housing zone and past the electronics module to cool the electronics module before entering the fan.

### SUMMARY OF THE INVENTION

Therefore, an object of the present invention is to provide an electric power tool having a ventilating unit which can more effectively dissipate heat generated in the electric power tool.

According to the present invention, an electric power tool includes a main frame, a flywheel, a tool body, a driving unit, and a ventilating unit. The main frame extends in a longitudinal direction. The flywheel is mounted in the main frame, is rotatable about a wheel axis in a transverse direction relative to the longitudinal direction, and has a wheel rim formed with a force transmitting portion. The tool body is disposed to be actuatable by the force transmitting portion. The driving unit is disposed on the main frame, and is coupled to drive the flywheel to rotate about the wheel axis so as to impart kinetic energy to the tool body through the force transmitting portion. The ventilating unit is mounted to rotate with the flywheel about the wheel axis, and is disposed to be spaced apart from the flywheel in the transverse direction. The ventilating unit is configured such that when the flywheel is driven to rotate about the wheel axis, cooling air is generated by rotation of the ventilating unit to blow inwardly into an interior of the main frame.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded view of a portion of an electric power tool according to a preferred embodiment of this invention;

FIG. 2 is a perspective view of the preferred embodiment in an assembled state; and

FIG. 3 is a cross-sectional view along line III-III of FIG. 2.

### DETAILED DESCRIPTION OF THE PREFERRED EMBODIMENT

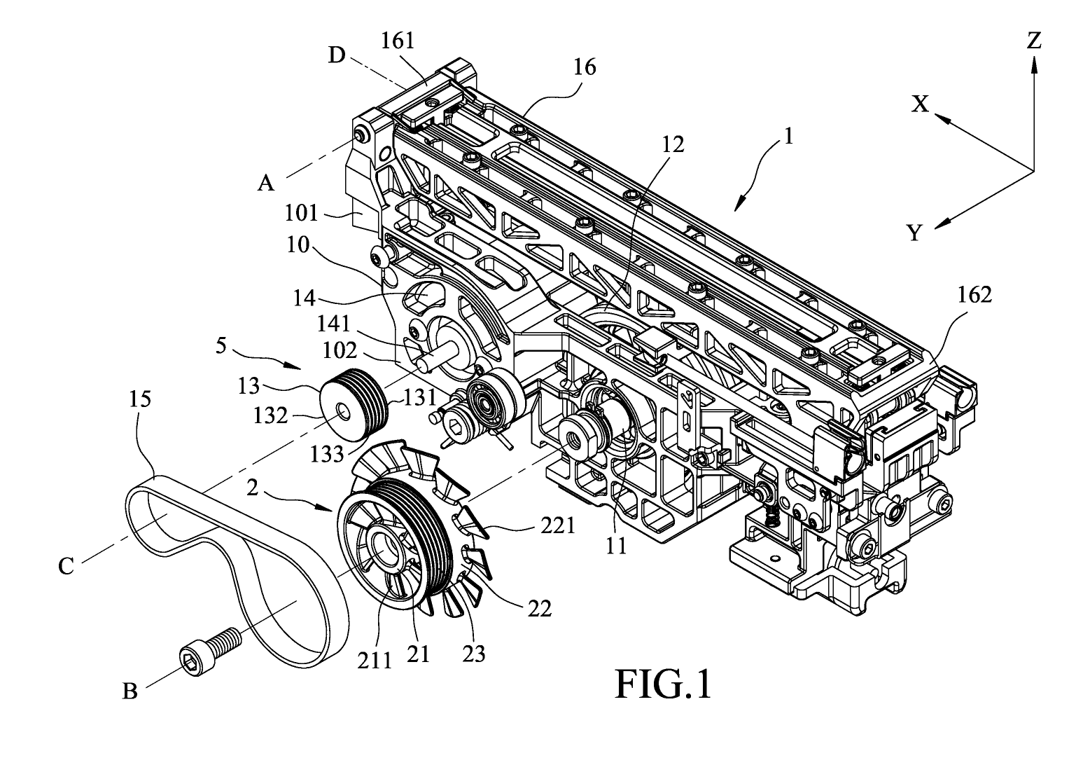

Referring to FIGS. 1 to 3, an electric power tool 1 according to a preferred embodiment of this invention is shown to include a main frame 10, a carrier frame 16, a flywheel shaft 11, a flywheel 12, a driving unit 5, a tool body 17, and a ventilating unit 2, which are disposed in a housing body (not shown).

The main frame 10 extends in a longitudinal direction (X), and has top and bottom portions 101, 102 opposite to each other in an upright direction (Z) transverse to the longitudinal direction (X).

The carrier frame 16 has a pivot end 161 and a positionable end 162 that are opposite to each other in the longitudinal direction (X). The pivot end 161 is pivotally mounted on the top portion 101 of the main frame 10 about a pivot axis (A). The positionable end 162 is angularly movable about the pivot axis (A) between upper and lower positions. For operation of the carrier frame 16, reference can be made to U.S. Pat. No. 8,511,532B2, the disclosure of which is incorporated in its entirety herein by reference.

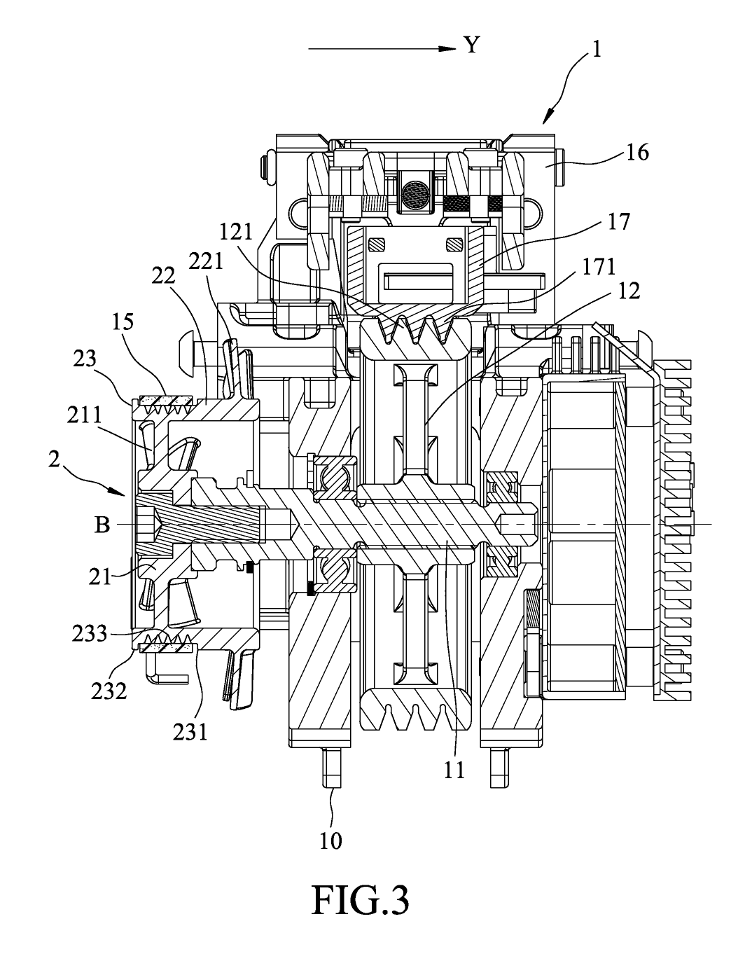

The flywheel 12 is mounted in the main frame 10 between the top and bottom portions 101, 102, and is rotatable about a wheel axis (B) in a transverse direction (Y) relative to the longitudinal direction (X). As best shown in FIG. 3, the flywheel 12 has a wheel rim formed with a force transmitting portion 121.

The tool body 17 is disposed to be actuatable by the force transmitting portion 121. The tool body 17 is a striking unit which is linearly slidably mounted on the carrier frame 16 along a striking route (D) in the longitudinal direction (X) , and which is disposed to be displaceable between a normal position and a ready position. The striking unit 17 is configured such that when the positionable end 162 is displaced to the lower position, the striking unit 17 is displaced to the ready position to thereby be actuated by the force transmitting portion 121 to dash along the striking route (D).

The driving unit 5 is disposed on the main frame 10, and is coupled to drive the flywheel 12 to rotate about the wheel axis (B), so as to impart kinetic energy to the striking unit 17 through the force transmitting portion 121, thereby permitting the striking unit 17 to dash along the striking route (D).

In this embodiment, the force transmitting portion 121 has first teeth 121. The striking unit 17 has mating second teeth 171 engageable with the first teeth 121. When the positionable end 162 is displaced to the lower position to thereby displace the striking unit 17 to the ready position, the mating second teeth 171 are brought into kinetic contact with the first teeth 121 to thereby permit the flywheel 12 to impart the kinetic energy to the striking unit 17 so as to enable the striking unit 17 to dash along the striking route (D).

The driving unit 5 includes a drive pulley 13, a motor 14, a driven pulley 23, and a belt 15. The motor 14 has an output shaft 141 rotatable about a shaft axis (C) substantially parallel to the wheel axis (B). The drive pulley 13 is coupled for rotation with the output shaft 141. The driven pulley 23 is coaxially rotatable with the flywheel 12. The belt 15 is trained on the drive and driven pulleys 13, 23 to permit the driven pulley 23 to be driven by the drive pulley 13. The pivot axis (A), the wheel axis (B), and the shaft axis (C) are substantially parallel to one another.

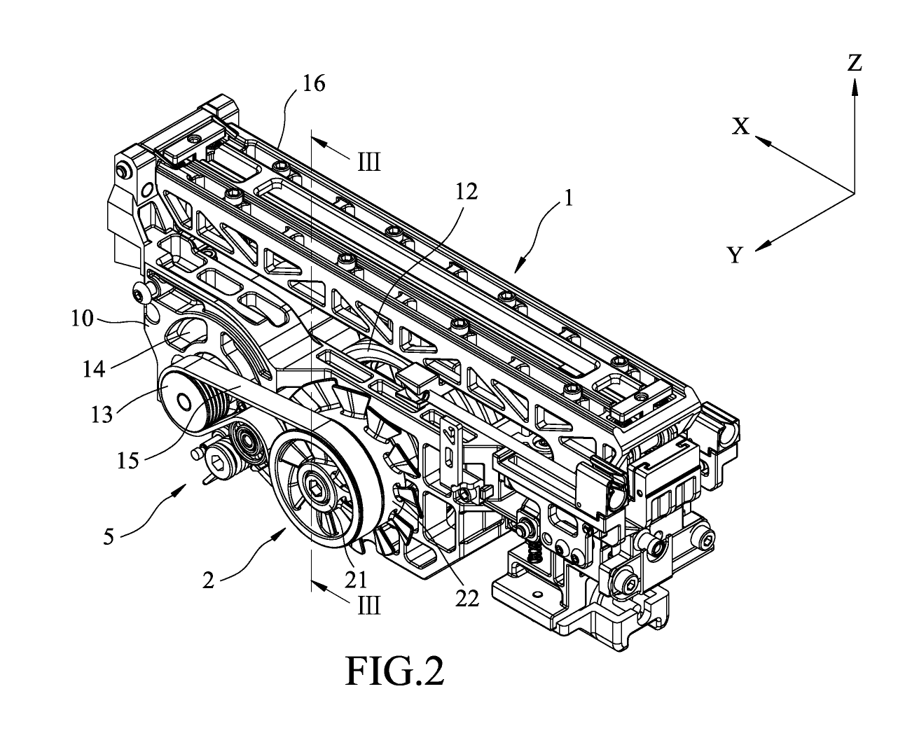

As shown in FIGS. 1 and 2, the drive pulley 13 includes first inner and outer flanges 131, 132 disposed opposite to each other in the transverse direction (Y) to form therebetween a first groove 133 which is configured to be in frictional engagement with the belt 15. As best shown in FIG. 3, the driven pulley 23 includes second inner and outer flanges 231, 232 disposed opposite to each other in the transverse direction (Y) to form therebetween a second groove 233 which is configured to be in frictional engagement with the belt 15. Thus, when the belt 15 is trained on the driving and driven pulleys 13, 23, the driven pulley 23 can be driven by the drive pulley 13 by virtue of the belt 15.

Preferably, the flywheel 12 and the driven pulley 23 are spaced apart from each other in the transverse direction (Y) , and are mounted on the flywheel shaft 11 to permit the flywheel 12 to be driven by the driven pulley 23 to thereby rotate therewith. In this embodiment, the flywheel 12 is in frictionally engagement with the flywheel shaft 11.

The ventilating unit 2 is mounted to rotate with the flywheel 12 about the wheel axis (B), and is disposed to be spaced apart from the flywheel 12 in the transverse direction (Y). The ventilating unit 2 is configured such that when the flywheel 12 is driven to rotate about the wheel axis (B), cooling air is generated by rotation of the ventilating unit 2 to blow inwardly into an interior of the main frame 10.

In this embodiment, the ventilating unit 2 includes a first hub body 21, a plurality of first blades 211, a second hub body 22, and a plurality of second blades 221. Preferably, the ventilating unit 2 and the driven pulley 23 are formed in one piece to be spaced apart from the flywheel 12 in the transverse direction (Y).

The first hub body 21 is coaxially mounted on and rotated with the flywheel shaft 11. Each of the first blades 211 extends radially and outwardly from the first hub body 21, and the first blades 211 are angularly displaced from each other about the wheel axis (B). In this embodiment, the first hub body 21 is sleeved on the flywheel shaft 11, and the first hub body 21 is in frictional engagement with the flywheel shaft 11. Thus, when the driven pulley 23 is driven to rotate by the drive pulley 13, the first hub body 21 and the flywheel shaft 11 also rotate therewith.

The second hub body 22 is disposed to be coaxially mounted on and rotated with the flywheel shaft 11 and is configured to extend from the second inner flange 231 toward the flywheel 12 so as to rotate with the driven pulley 23. The second blades 221 extend radially and outwardly from the second hub body 22, and are angularly displaced from each other about the wheel axis (B).

The first and second blades 211, 221 are configured to generate the cooling air when the first and second hub bodies 21, 22 rotate with the flywheel shaft 11.

In this invention, the first and second blades 211, 221 are disposed in proximity to the housing body (not shown) of the electric power tool 1. By providing on the housing body two ventilation grids (not shown) that are opposite to each other in the transverse direction (Y), cooling air outside the housing body can be drawn by the ventilating unit 2 into the housing body through one of the ventilation grids to blow in the transverse direction (Y) and to flow out of the housing body through the other one of the ventilation grids, thereby dissipating the heat generated in the housing body by, for example, the flywheel 12, the motor 14, the control unit (not shown), etc. Preferably, each of the ventilation grids is disposed at a position corresponding to the first and second blades 211, 221.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. An electric power tool comprising:
a main frame extending in a longitudinal direction;
a flywheel which is mounted in said main frame, which is rotatable about a wheel axis in a transverse direction relative to the longitudinal direction, and which has a wheel rim formed with a force transmitting portion;
a tool body disposed to be actuatable by said force transmitting portion;
a driving unit disposed on said main frame, and coupled to drive said flywheel to rotate about the wheel axis so as to impart kinetic energy to said tool body through said force transmitting portion; and
a ventilating unit mounted to rotate with said flywheel about the wheel axis, and disposed to be spaced apart from said flywheel in the transverse direction, said ventilating unit being configured such that when said flywheel is driven to rotate about the wheel axis, cooling air is generated by rotation of said ventilating unit to blow inwardly into an interior of said main frame.

2. The electric power tool of claim 1, wherein said main frame has top and bottom portions opposite to each other in an upright direction transverse to both the longitudinal direction and the transverse direction,
said electric power tool further comprising a carrier frame having a pivot end pivotally mounted on said top portion of said main frame about a pivot axis, and a positionable end which is opposite to said pivot end in the longitudinal direction, and which is angularly movable about the pivot axis between upper and lower positions,
said tool body being a striking unit which is linearly slidably mounted on said carrier frame along a striking route in the longitudinal direction, and which is disposed to be displaceable between a normal position and a ready position, said striking unit being configured such that when said positionable end is displaced to the lower position, said striking unit is displaced to the ready position to thereby be actuated by said force transmitting portion to dash along the striking route.

3. The electric power tool of claim 2, wherein said force transmitting portion has first teeth,
said striking unit having mating second teeth engageable with said first teeth such that when said striking unit is displaced to the ready position, said mating second teeth are brought into kinetic contact with said first teeth to thereby permit said flywheel to impart the kinetic energy to said striking unit so as to enable said striking unit to dash along the striking route.

4. The electric power tool of claim 1, wherein said driving unit includes a motor having an output shaft, and a driven pulley coupled to and driven by said output shaft, said driven pulley being coaxially rotatable with said flywheel.

5. The electric power tool of claim 4, wherein said output shaft is rotatable about a shaft axis substantially parallel to the wheel axis, said driving unit further including a drive pulley coupled for rotation with said output shaft, and a belt trained on said drive and driven pulleys to permit said driven pulley to be driven by said drive pulley.

6. The electric power tool of claim 5, further comprising a flywheel shaft, said flywheel and said driven pulley being mounted on said flywheel shaft to permit said flywheel to be driven by said driven pulley to thereby rotate therewith.

7. The electric power tool of claim 6, wherein said driven pulley includes inner and outer flanges disposed opposite to each other in the transverse direction to form therebetween a groove which is configured to be in frictional engagement with said belt.

8. The electric power tool of claim 7, wherein said ventilating unit includes
a hub body disposed to be coaxially mounted on and rotated with said flywheel shaft, and
a plurality of blades each extending radially and outwardly from said hub body, said blades being angularly displaced from each other about the wheel axis and being configured to generate the cooling air when said hub body rotates with said flywheel shaft.

9. The electric power tool of claim 8, wherein said hub body is sleeved on said flywheel shaft, each of said blades being configured to extend radially and outwardly from said hub body.

10. The electric power tool of claim 8, wherein said hub body is configured to extend from said inner flange toward said flywheel so as to rotate with said driven pulley.
